(19) United States
(12) Patent Application Publication
(10) Pub. No.: US 2011/0042961 A1
(43) Pub. Date: Feb. 24, 2011

(54) DEVICE FOR GENERATING POWER

(75) Inventor: Frits Jos Van Breemen-Schneider, Veenwouden (NL)

Correspondence Address: MORGAN, LEWIS & BOCKIUS, LLP (SF), ONE MARKET SPEAR STREET TOWER, SAN FRANCISCO, CA, 94105, US

(73) Assignee: Brestac Holding BV, Veenwouden (NL)

(21) Appl. No.: 12/937,037

(22) PCT Filed: Apr. 9, 2009
(86) PCT No.: PCT/NL09/00088

§ 371 Date: Nov. 4, 2010

(30) Foreign Application Priority Data
Apr. 10, 2008 (NL) 1035278

(51) Int. Cl. F03D 9/00; H02K 21/12

(52) U.S. Cl. 290/55; 310/156.02

(57) ABSTRACT

The present invention relates to a motor and/or dynamo, a vehicle or wind turbine provided with such a motor and/or dynamo. The motor/dynamo comprises
a device for generating power, comprising: a rotor; a stator; at least two permanent magnets arranged in a mutually opposed orientation on one of the rotor and the stator; and at least two coils on the other of the rotor and the stator,
characterized in that the coils are disposed in an axial orientation and the magnets in radial orientation.

The present invention relates to a device for generating power.

Such a device preferably has a dual function as dynamo and as motor. In the latter operating mode a control is or will be provided for actuating the coils with drive currents such that the rotor is here set into motion. In a specific embodiment the motor can be incorporated into a wheel or on a drive shaft of a wheel in order to drive a vehicle with the wheel thereon.

Motors and/or dynamos known in practice are for instance applied in a vehicle in order to enable driving of the vehicle as motor or to generate energy as dynamo. These motors and dynamos increase the weight of such a vehicle considerably. Among other things, such weight increases the fuel consumption of a vehicle, increases wear and maintenance costs, reduces performance of the vehicle such as acceleration, increases the impact in the case of a collision, and increases production costs.

The present invention has for its object to provide for a more efficient application of motors and/or dynamos.

This object is achieved with a device for generating power, such as a motor and/or dynamo, as according to claim 1.

The device provides a rotor and a stator. The magnets, placed on the rotor, are rotated by alternating actuation of the coils of the stator. A shaft can be driven by the rotation of the rotor. This finds application in, among others, the driving of a vehicle, such as a passenger car, truck, bus and aircraft. This relates to the operation of the device as motor. Conversely, an electric field can be generated in the coils of the stator by rotating the rotor with the magnets. A battery can for instance hereby be charged in a vehicle. Energy can for instance also be supplied to an electricity grid by using the device, operating here as a dynamo, in for instance a wind turbine. By providing the at least two permanent magnets in a mutually opposed orientation (north-south) on the rotor (or stator) in a radial direction the length of the path of the electromagnetic flux is limited relative to known devices. The radial direction is here as seen from for instance the motor axis. The coils are here placed in axial direction relative to this axis. Less saturation for instance hereby occurs, and greater power can be generated. In addition, this power is further increased in that the magnets and the coils can in this way be placed on a greater radius due to the orientation of the magnets and coils that is employed. This results in a greater generated power at the same mass, or in a smaller mass of the motor/dynamo when the same power is or can be generated. The total mass of for instance a vehicle provided with a device according to the invention is hereby clearly reduced. By way of indication, experiments have shown that a mass of a PM motor for a vehicle can be reduced from about 60-80 to 15-20 kilograms. The consumption and wear to parts of a vehicle are hereby reduced. In addition, the overall production costs of for instance a vehicle provided with a device according to the invention are also reduced.

An additional advantage is that an improved cooling is realized due to the specific configuration of the coils and the magnets according to the present invention. This is brought about in that the limited distance between the magnet and the coil lies outside the radial plane. This gap or opening lies in axial direction in the device according to the present invention. This means that a relatively greater cooling of the coils can be realized by providing a larger space in radial direction above the coils. Gaps or distances used between a coil and a magnet amount to about 2.5-6 millimetres, while the space above the coil amounts for instance to about 8 millimetres. These specific dimensions do of course depend on the relevant application. The greater distance above the coils therefore results in more space for cooling by for instance air flowing by. Greater rotation speeds can for instance be realized due to this improved cooling.

In an advantageous embodiment the operation of the motor and the dynamo is combined. This can find application for instance in a vehicle in which the device functions as motor for the purpose of driving the wheels, and thereby the whole vehicle. The same device can be used, for instance during braking, for the purpose of generating energy as dynamo and storing thereof in a battery. The magnets are preferably arranged in a set round the rotation axis. In addition to placing of the magnets on the rotor, it is also possible to provide the magnets on the stator and the coils on the rotor.

In an advantageous preferred embodiment according to the present invention a second set of magnets is provided at a distance from the first set, wherein the coils extend between the first and the second set of magnets.

In terms of construction, a so-called dual axial motor assembly is realized by providing two sets of magnets with the coils therebetween. Coil packages are here attached to the stationary parts of the motor (or dynamo). The permanent magnetic field is formed by the magnets (north-south). These magnets are alternately actuated, depending on among other factors the motor speed, by the stator coils of the coil package. The path of the magnetic flux runs via the axially placed coils between the magnets or the discs/flanges to which the magnets are attached. The path of the flux is hereby shortened, so that the efficiency of the device is further increased. The quantity of coils and magnets depends on the application used. An additional advantage is that, if desired, a lower rotation speed can suffice for the purpose of generating the same power. At the same time higher rotation speeds are also possible due to the stable configuration. Rotation speeds can thus be realized in for instance the range of 500-8000 revolutions per minute. When the motor is placed as direct drive in a wheel of a vehicle, rotation speeds up to about 2000 revolutions per minute can be realized.

In a preferred embodiment according to the present invention the first and the second set of magnets are offset relative to each other.

It is known in practice that, particularly during starting of for instance a drive of a vehicle, this takes place in jolting manner (cogging). This reduces the comfort of a driver. In addition, this increases for instance the mechanical load on components of the vehicle. A smoother rotation behaviour of the rotor is realized by providing an offset between the first and second set of magnets. The resistance to starting is also lower, whereby less startup power is required. The offset between these opposite magnets can amount to 50%. This means that the middle of a magnet on a first flange lies in axial direction directly opposite the transition between two adjacent magnets on a second flange. The smoothest movement or rotation of the rotor is hereby obtained, wherein the jolting movement is prevented as far as possible. It is also possible to make the offset somewhat smaller, for instance 30%, i.e. a somewhat smaller relative rotation of the magnets on the two rings relative to each other. The chosen offset depends on the relevant application and on the trade-off between comfort, in the form of smooth rotation, and efficiency.

By not placing the magnets on the flanges perpendicularly above each other, i.e. by realizing the above described offset, the so-called cogging torque is improved. In order to realize the offset, a rotation is preferably chosen of a maximum 30% rotation of the north pole relative to the south pole on the opposite disc.

The coils are preferably arranged between two substantially parallel rings. The rings are preferably of a non-conductive material, and more preferably of a 5 millimetre glass fibre sheet. The coils are preferably provided in a recess in the rings, wherein a cap or hat is provided at the outer end of the coil. The coil is held fixedly in the ring by this cap or hat. By providing this cap in a non-conductive material, for instance a plastic, the magnetic field is not obstructed. The material must be heat-resistant, preferably up to a temperature of at least 200° C. The cap has for instance a thickness of about 1.5 millimetres. It is also possible to provide recesses in the rings instead of holes such that the coils are as it were clamped between these rings. In an advantageous embodiment the rings are connected to a respective outer end of a bush. The bush is herein connected to the rings on the radial outer side thereof. Alternatively, the bush is connected to the rings on the radial inner side thereof.

In an advantageous preferred embodiment each of the first and the second set of magnets is arranged on respectively one of two substantially parallel flanges.

The performance of the device is increased by providing two flanges having magnets. The generated flux runs from a magnet via the axially placed coil to a magnet on a parallel second flange. The efficiency of the device is hereby increased further. It is also possible to arrange more than two flanges provided with magnets. A greater power can be generated by this stacking of flanges.

In a further advantageous preferred embodiment according to the present invention the flanges are each connected to a respective outer end of a bush.

If such an arrangement is desired, it may be desirable and/or useful that the device can be closed off from the outside world. This is not feasible with conventional configurations, or at least a closed configuration is not known from the prior art. This is relevant for, among others, an in-wheel motor for an electric vehicle. It is important here that grime from the road surface does not enter the motor. By connecting the flanges with the magnets to a bush a substantially closed configuration is obtained with which dirt is kept out as much as possible. For the purpose of draining moisture a slit or gap is left open between the rotor and stator to enable drainage of moisture. In a first preferred embodiment with inner rotor, the cylinder is connected to the flanges on the radial outer side thereof. In this embodiment there are no moving parts on the outer side. This is advantageous for instance in the application in a gearbox. Additional advantages are the simpler balancing and the lighter construction. In an alternative second preferred embodiment with outer rotor, the cylinder is connected to the flanges on the radial inner side thereof. This is advantageous since a relatively greater moment of inertia can be generated. In addition, the assembly of this embodiment is relatively simpler and also cheaper. A relatively closed construction is obtained in both embodiments.

The bush for the rings or the cylinder for the flanges forms a base component for the rotor or for the stator. This of course depends on the chosen embodiment of the device according to the present invention.

In a further advantageous embodiment according to the invention the device comprises a control for alternate switching of the coils between a first magnetic action and a second magnetic action on the permanent magnets for the purpose of applying the device as motor.

By providing alternating currents through the coils, wherein adjacent coils are successively actuated, the rotor is set into motion in per se known manner. The coils are preferably divided here into three groups which are successively actuated. It follows herefrom that the number of coils will in this case amount to a multiple of three.

In an advantageous preferred embodiment according to the invention the device is provided with coupling means for coupling the device to a gearbox.

Another advantage is that, for instance when the device is mounted on a gearbox, the driven flange can with a small modification serve as coupling means in the form of a friction plate for the mounting of a clutch plate with clutch assembly. An additional advantage is that a compact device can be obtained with minimum mass.

The invention further relates to a vehicle and a wind turbine provided with a motor and/or dynamo as described above.

The invention further relates to the use of a device as described above, wherein this device functions as dynamo for generating energy. This application is relevant for the purpose, among others, of recovering energy during braking of a vehicle. It can however also be applied in, among other devices, wind turbines.

The use as dynamo and the vehicle and the wind turbine provide the same effects and advantages as described particularly in respect of the application as motor.

The present invention will be described hereinbelow with reference to the accompanying drawings of non-limitative exemplary embodiments within the scope of the present invention, wherein the same or similar components, elements and features are designated with the same references, and in which:

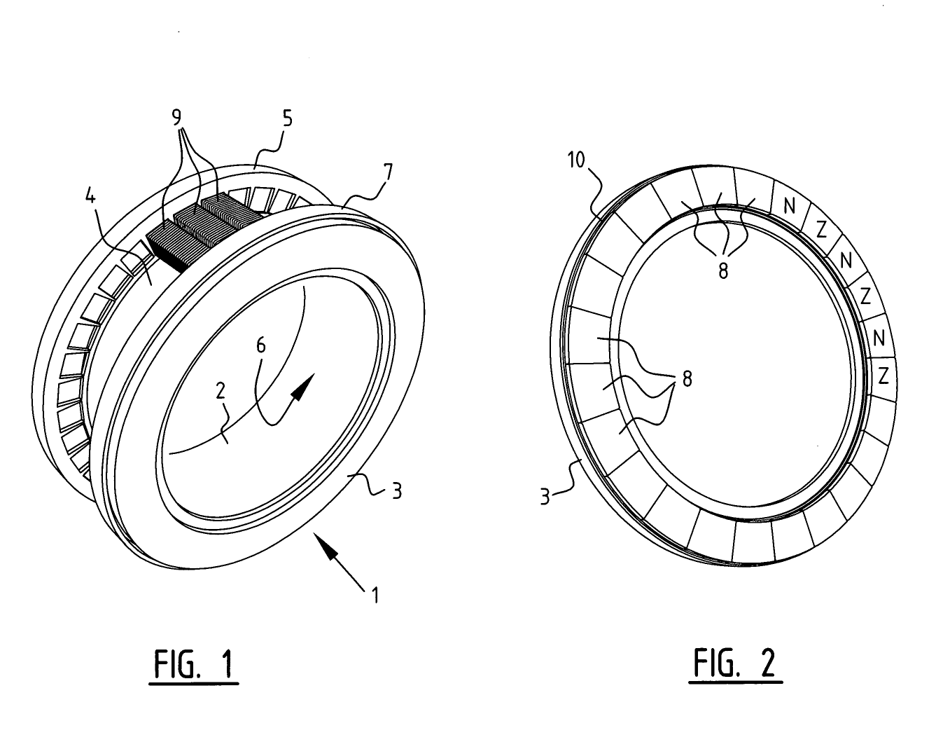

FIG. 1 shows a view of a first embodiment with an inner rotor;

FIG. 2 shows a view of a flange with magnets from FIG. 1;

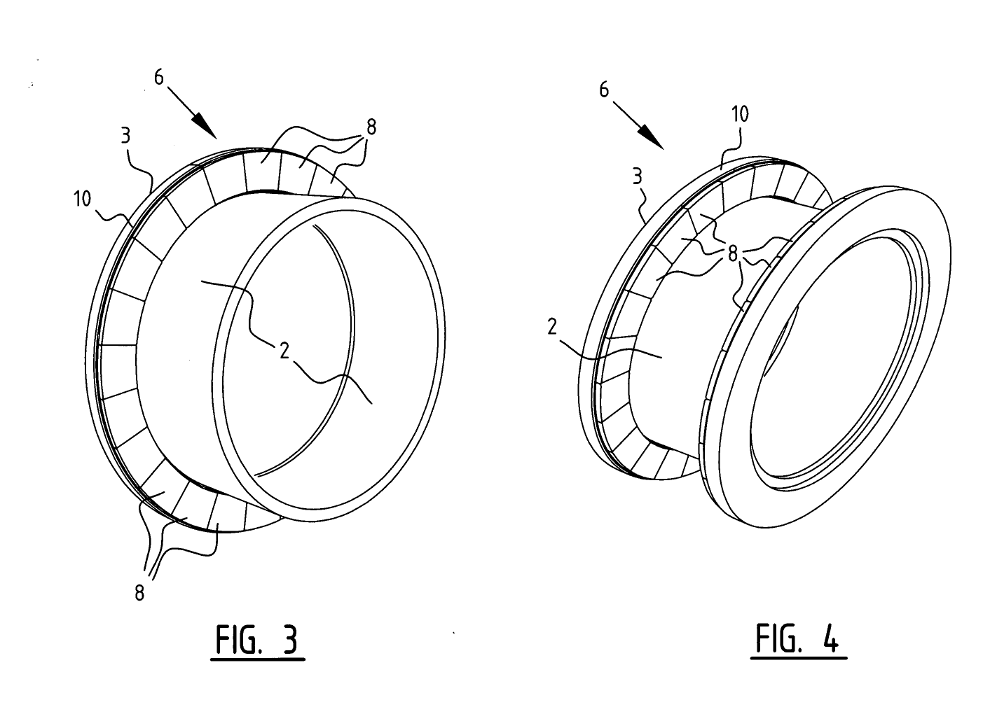

FIG. 3 shows a view of another flange with bush/cylinder of FIG. 1;

FIG. 4 shows an assembly of bush/cylinder with flange of FIGS. 2 and 3;

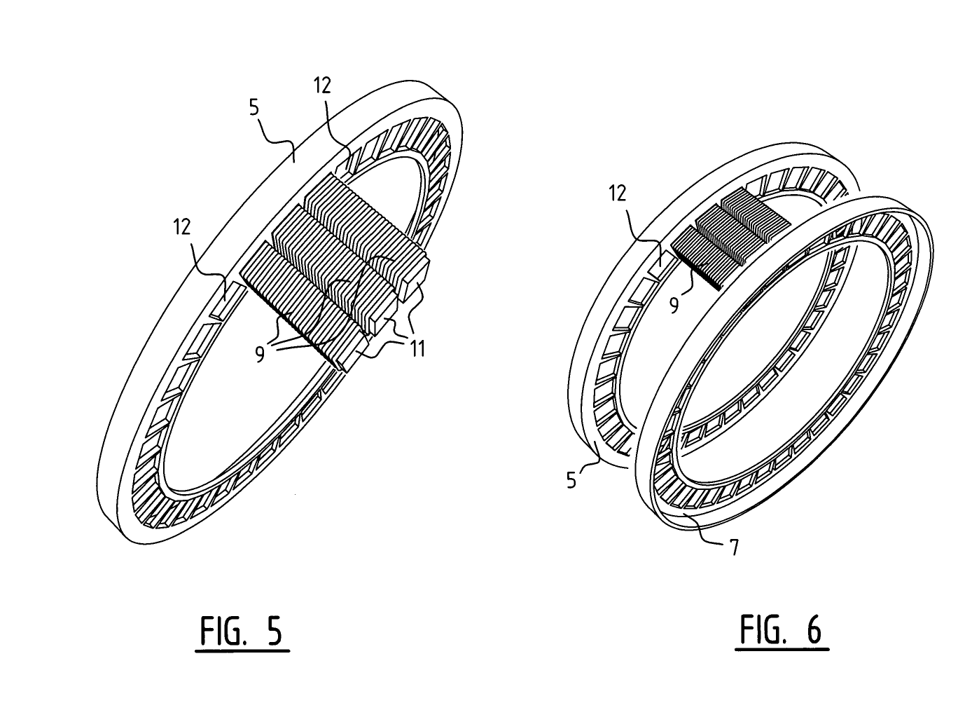

FIG. 5 shows a view of the stator part of FIG. 1;

FIG. 6 shows a view of an assembled stator;

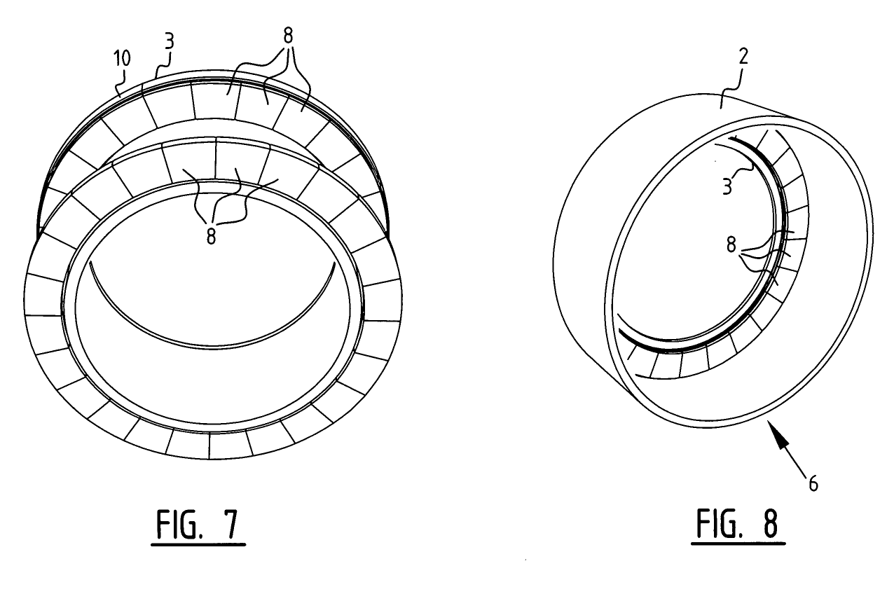

FIG. 7 shows a view of a rotor with offset between two sets of magnets;

FIG. 8 shows a second embodiment with outer rotor;

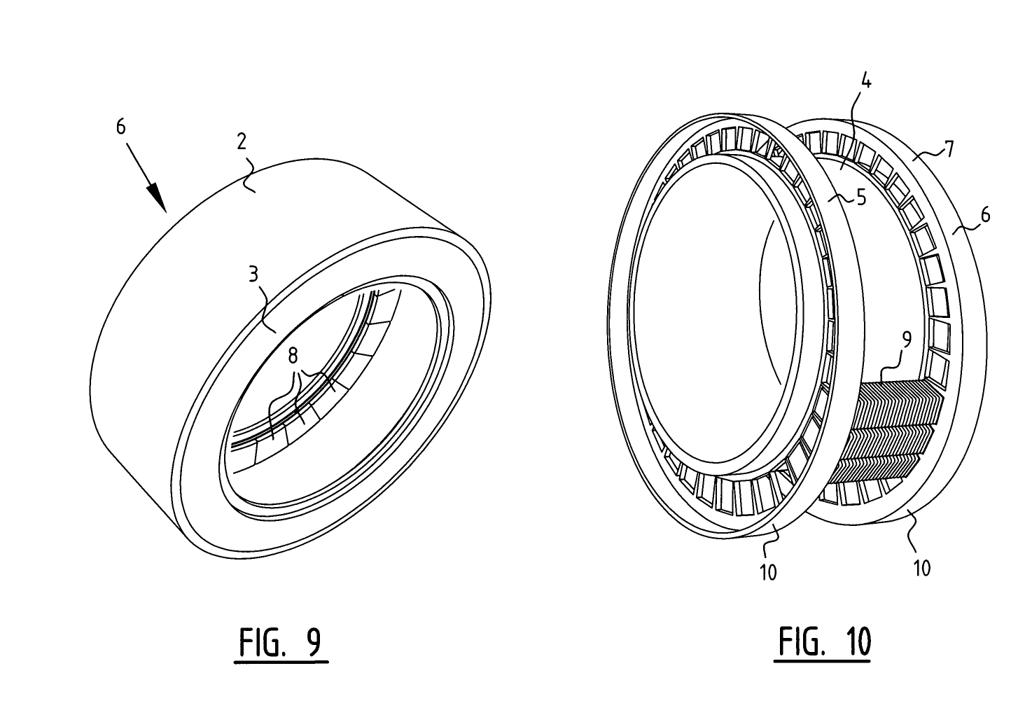

FIG. 9 shows a view of the rotor of FIG. 8;

FIG. 10 shows a view of the stator according to the second embodiment;

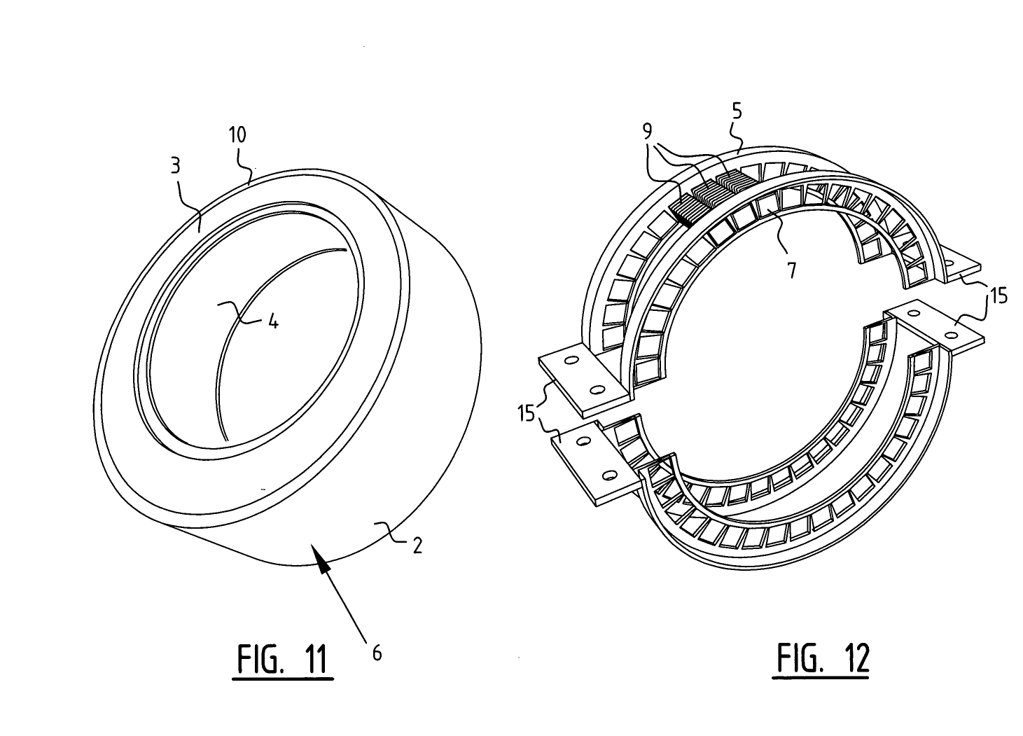

FIG. 11 shows a view of an assembly according to the second embodiment;

FIG. 12 shows a view of an alternative stator element;

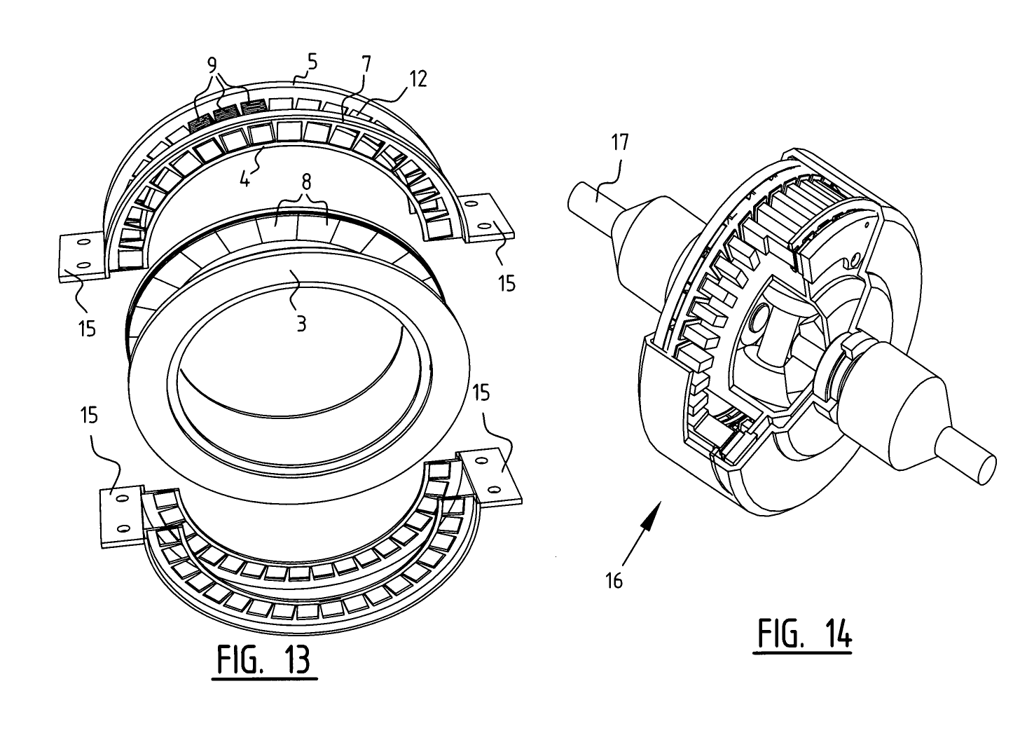

FIG. 13 shows a view of the element of FIG. 12 in the second embodiment;

FIG. 14 shows a view of embodiment with integrated differential;

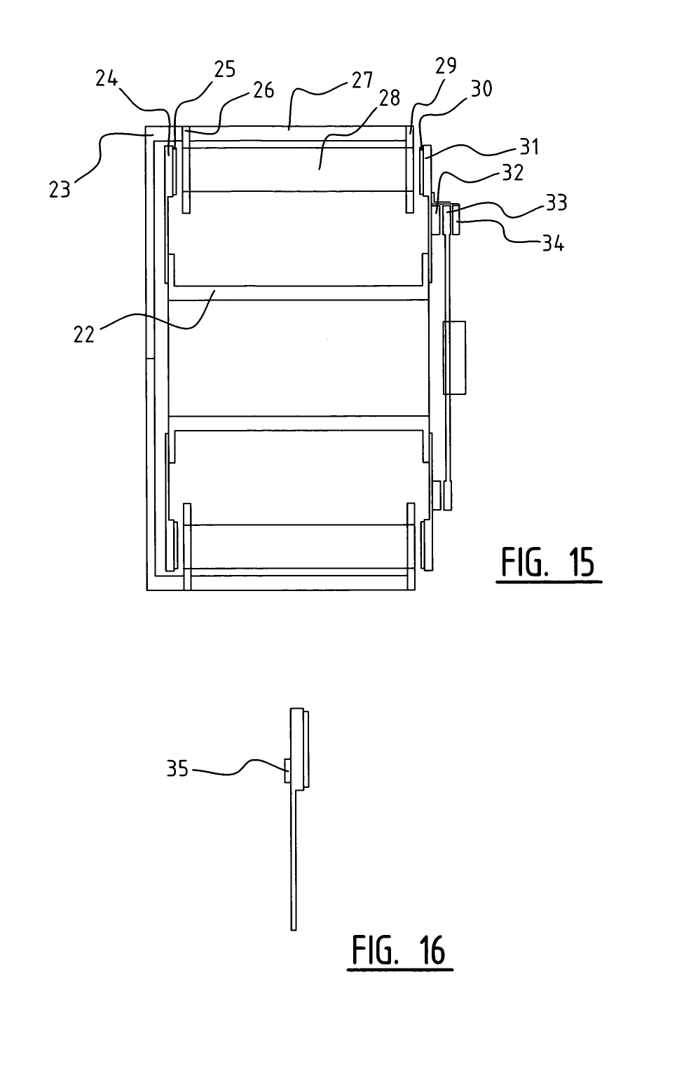

FIG. 15 shows a motor with clutch according to the invention;

FIG. 16 shows a balancing ring for a rotor in a motor according to the invention; and

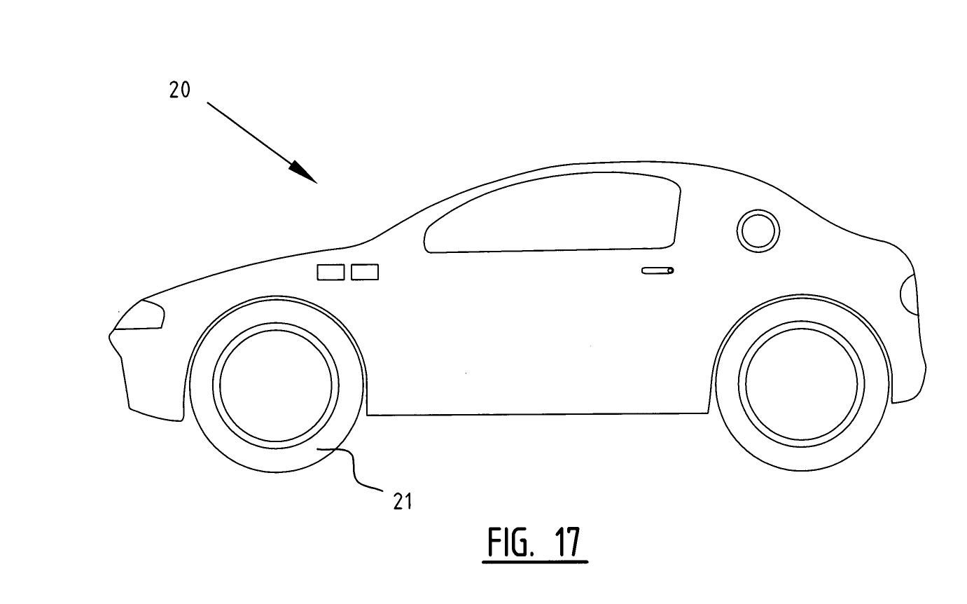

FIG. 17 shows a view of a vehicle provided with a drive according to the invention.

FIGS. 1-7 and FIGS. 12-13 show a motor/dynamo 1 having on the inside a rotor with magnets, wherein the inner rotor can be compared to a bobbin in which the magnets are positioned on the inner side of the cheeks in accordance with a first embodiment. FIGS. 8-11 show the motor/dynamo having on the outside a rotor comprising magnets in accordance with a second embodiment.

The rotor 6 in motor/dynamo 1 in FIG. 1 can be compared to a bush 2 with outward folded outer ends or flanges 3 on the axial outer ends of bush 2, wherein magnets 8 are arranged on the inner wall of each of the flanges 3. These flanges 3 are also referred to as cheeks, and are provided on the inner side with the magnets 8. FIG. 1 relates to the embodiment with inner rotor. In the embodiment of FIGS. 8-11 bush 2 is arranged on the radial outer side of flanges 3. FIG. 8 relates to the embodiment with outer rotor.

Both types of motor/dynamo of FIGS. 1-7; 8-11; and FIGS. 12-13 are based on the same operating principle.

FIG. 1 shows a partial assembly of a dual axial PM motor 1. Here (only) three (wound) coils 9 are shown in a grouping which is also referred to as a stack. The design of FIGS. 1-7 and 12; 13 comprises a freely chosen number of coils 9 or stacks, each of three coils, in multiples of three such as three, six, nine, twelve, fifteen and so on, depending on the diameter and the configuration of the stacks on or between suspension rings 5, 7 and the form and size of coils 9 in the groups or stack. The shown design comprises thirty-six of the stacks of coils 9 and twenty-four magnets 8 per flange 3, so forty-eight magnets in all. Other numbers are of course possible depending on the application and the power desired. Seventy-two coils can for instance thus be realized for an application in a wind turbine, this subject to the relevant dimensions of the wind turbine. In the shown embodiment each coil is provided with seventy-two windings. The number and thickness of the windings or coils can be chosen subject to, among other factors, the application and the power desired.

FIGS. 1-7 and 12; 13 show the assembly of the dual axial PM motor/dynamo with magnets 8 on an inward lying flange of rotor 6, or flanges on bush 2.

This is the first embodiment. Bush 2 can optionally be provided on the side of for instance coils 9 with an insulating layer 4 fixedly connected to rings 5, 7. A gap-like opening is provided between rings 5, 7 and flanges 3.

On the one hand this makes possible the relative movement of flanges 3 relative to rings 5, 7. On the other hand moisture can be discharged through this opening. A shaft (not shown) can be provided on the inner side of bush 2, i.e. in the direction of the centre or the rotation axis. This shaft can optionally be connected via a type of spokes to bush 2 or be directly connected to bush 2. This of course depends on the dimensions of the shaft and bush 2. Holes (not shown) can also be provided in bush 2 in order to thereby further reduce the weight of motor/dynamo 1. The diameter of the shown bush 2 amounts to about 270 millimetres, wherein the commonly occurring range for vehicles lies between 200 and 350 millimetres. Other diameters are of course possible. A diameter of about 800 millimetres can for instance thus be realized for a bus or truck. In the shown embodiment the coils on the underside lie substantially against each other. An even higher efficiency can optionally be realized by making use of a trapezium shape.

FIG. 2 shows a steel ring which forms flange 3, with magnets 8 thereon, wherein magnets 8 are ordered in north-south-north-south configuration. Chosen stack 9,9,9 opposite magnets 8,8,8 are in a ratio of multiples of 3:2.

The return path of the magnetic flux is located through the steel discs or flanges 3 on which magnets 8 are arranged. Magnets 8 are enclosed on the outer sides by a collar 10 on the steel ring or flanges 3. This collar 10 prevents magnets 8 becoming detached due to vibrations.

FIG. 3 shows a part of rotor 6 with several flanges 3 on bush 2. Flanges 3 of rotor 6 with magnets 8 thereon are mutually connected via bush 2, and this provides for the torque transmission from the motor/dynamo to the load to be driven (see FIG. 14).

FIG. 4 shows the assembled rotor 6 of the dual axial permanent magnet motor/dynamo 1 as assembly of the components shown in FIGS. 2 and 3.

FIG. 5 shows one of the rings 5, 7 with stacks of coils 9 round cores 11 which protrude into recesses 12. The coils round a core 11 protrude into a recess 12 in each of the rings 5, 7. Rings 5, 7 are stationary and thus form the stator, which is connected to the fixed world so as to thus form the stator.

FIG. 6 shows the mounted suspension of coils 9 round cores 11 in rings 5, 7 in groups or stacks of three coils 9 each. This stack suspension is placed between the two rings 5, 7 (see FIG. 1).

FIG. 7 shows clearly the offset or distance between the two opposite magnets 8 on flanges 3, wherein the closest flange in the shown view is omitted, while magnets 8 are shown. This serves to reduce the cogging torque and to achieve a smooth rotation/running property of motor 1. The startup behaviour of the motor/dynamo is also improved, stalling being prevented during starting, which means setting the rotor into operation.

FIG. 8 shows a second embodiment of the invention with flanges 3 on bush 2 lying on the outer side thereof. The cheek or flange 3 with magnets 8 is mounted on a thus formed outer bush 2, wherein the closest flange 3 in the figure is omitted for the sake of clarity.

FIG. 9 shows rotor 6 with bush 2 arranged on the outside, and cheeks or flanges 3 with magnets 8 mounted on the inner side thereof are clearly shown here. This unit is the outer rotating rotor of the motor/dynamo. The drum or rotor 6 can only be closed with a flange 3 relative to the situation of FIG. 8 when the assembled cylinder 4 with rings 5, 7 and coils 9 arranged therebetween (FIG. 10) is manufactured, and the cylinder can then be placed in the drum freely of the rotor magnets 8 and flanges 3.

FIG. 10 thus shows the assembled cylinder 4 with rings 5, 7 and coils 9 in stacks therebetween. This assembly is mounted inside, but free of the rotor, magnets and housing.

FIG. 11 shows the fully assembled motor/dynamo with outer rotor.

The shown assembly has a weight of about 15-20 kilograms. The weight of course depends on the application. Combinations of shown and described measures for the first embodiment can also be applied to the second embodiment, and are therefore not repeated here.

FIG. 12 shows a two-part stack suspension for coils 9 for assembly in the inner rotor of the motor/dynamo. The two-part elements for suspension of coils 9 further comprise fastening points 15 for assembly of rings 5, 7 and for attachment of the stack suspension to the fixed world.

FIG. 13 shows the exploded assembly of an inner rotor motor.

FIG. 14 shows an embodiment 16 of a motor according to the invention with an integrated differential on an axle 17 of a wheel (not shown).

Space is hereby saved, as well as the overall weight being reduced.

FIG. 15 shows a motor according to the present invention provided with a rotor connecting bush 22 provided in a housing 23. Housing 23 is provided with a first rotor 24 on which magnets 25 are arranged. Housing 23 is further provided with a first stator suspension/insulation plate 26. Plate 26 is placed on a first outer end of central housing 27. A second stator suspension/insulation plate 29 is provided on the second outer end of central housing 27. A stator with copper-wound soft-iron core 28 is provided between plates 26, 29. Where the first rotor 24 is placed on a first outer end of stator 28, a second rotor 31 with magnets 30 is provided on a second outer end of stator 28. Rotor 31 is combined with friction ring 32 for the clutch. Clutch plate 33 connects the motor to the clutch assembly, of which a part 34 of the housing is shown in the present embodiment.

The integration of friction ring 32 with rotor 31 creates a wholly compact motor with a very low weight. In the shown embodiment the 70 kW motor with clutch and clutch assembly has a mass of less than 25 kg.

FIG. 16 shows a rotor with an additional balancing ring 35 for dynamic balancing of the rotor. In the shown embodiment the balancing is carried out by providing holes at desired positions in ring 35.

FIG. 17 shows a vehicle 20 provided with a wheel 21 in which a motor 1 according to the invention is arranged. Motor 1 can also function as dynamo during braking of vehicle 20. Such a function as dynamo can also be applied for a wind turbine (not shown) for the purpose of generating power in the form of electrical energy.

A cylinder embodiment (drum) of the motor according to the present invention is particularly suitable for so-called “in-wheel” motors, also referred to as hub motors. The magnet flanges here preferably form part of the hub. The number of components is hereby minimized and much mass saved. The mass is better distributed over the motor, whereby there is a relatively large amount of open space in the motor. An additional advantage is that cooling of the motor also becomes simpler as a result.

The embodiments in the figures show an advantageous arrangement of the diverse components, whereby the shown motor can be embodied with compact components preferably having a low weight. In a shown embodiment the weight of the complete stator is for instance 5.7 kg. For the complete motor this results in the 37 kW embodiment in an overall weight of about 13.5 kg, and in the 70 kW continuous motor in a weight of less than 20 kg.

The present invention is by no means limited to the above described preferred embodiments. The rights sought are defined by the following claims, within the scope of which many modifications can be envisaged. In addition to applications in vehicles and wind turbines, applications such as stairlifts, boats, cranes and the like are also possible.

1. Device for generating power, comprising: a rotor; a stator; at least two permanent magnets arranged in a mutually opposed orientation on one of the rotor and the stator; and at least two coils on the other of the rotor and the stator, characterized in that the coils are disposed in an axial orientation and the magnets in radial orientation.

2. Device as claimed in claim 1, wherein the magnets are arranged in a set round the rotation axis.

3. Device as claimed in claim 2, wherein a second set of magnets is provided at a distance from the first set as according to at least one of the claims 1 and 2, and wherein the coils extend between the first and the second set of magnets.

4. Device as claimed in claim 1, 2 or 3, wherein the first and the second set of magnets are offset relative to each other.

5. Device as claimed in at least one of the foregoing claims, wherein the coils are arranged between two substantially parallel rings.

6. Device as claimed in claim 5, wherein the rings are each connected to a respective outer end of a bush.

7. Device as claimed in claim 6, wherein the bush is connected to the rings on the radial outer side thereof.

8. Device as claimed in claim 6, wherein the bush is connected to the rings on the radial inner side thereof.

9. Device as claimed in at least one of the foregoing claims, wherein each of the first and the second set of magnets is arranged on respectively one of two substantially parallel flanges.

10. Device as claimed in claim 9, wherein the flanges are each arranged on a respective outer end of a cylinder.

11. Device as claimed in claim 10, wherein the cylinder is connected to the flanges on the radial outer side thereof.

12. Device as claimed in claim 10, wherein the cylinder is connected to the flanges on the radial inner side thereof.

13. Device as claimed in at least one of the foregoing claims, wherein one of the bush and the cylinder forms a base component for one of the rotor and the stator.

14. Device as claimed in at least one of the foregoing claims, further comprising a control for alternate switching of the coils between a first magnetic action and a second magnetic action on the permanent magnets for the purpose of applying the device as motor.

15. Device as claimed in at least one of the foregoing claims, wherein the device is further provided with coupling means for coupling the device to a gearbox.

16. Vehicle or wind turbine provided with a device as claimed in one or more of the foregoing claims.

17. Use of a device as claimed in at least one of the foregoing claims 1-15 as dynamo.
